(19) United States
(12) Patent Application Publication
(10) Pub. No.: US 2013/0273130 A1
(43) Pub. Date: Oct. 17, 2013

(54) NOVEL SOLID BAIT COMPOSITIONS USED FOR PROTECTING FRUITS FROM FRUIT FLY PESTS

(71) Applicants: Michal Mazor, Rehovot (IL); Ahmed Nasser, Jerusalem (IL)

(72) Inventors: Michal Mazor, Rehovot (IL); Ahmed Nasser, Jerusalem (IL)

(73) Assignee: THE AGRICULTURAL RESEARCH ORGANIZATION, Beit Dagan (IL)

(21) Appl. No.: 13/882,859

(22) PCT Filed: Nov. 1, 2011
(86) PCT No.: PCT/IL11/00848

§ 371 Date: May 30, 2013

Related U.S. Application Data
(60) Provisional application No. 61/408,660, filed on Nov. 1, 2010.

(51) Int. Cl. A01N 25/10

(52) U.S. Cl. CPC A01N 25/10
USPC 424/405; 424/84

(57) ABSTRACT

The present invention provides novel “green” solid bait compositions and their use thereof for protecting fruits from fruit fly pests.

### FIELD OF THE INVENTION

The present invention relates generally to the field of agricultural technology and more specifically to novel “green” solid bait compositions and their use thereof for protecting fruits from fruit fly pests.

### BACKGROUND OF THE INVENTION

Tephritidae is the true fruit flies family, which includes about 4000 species arranged in 500 genera. This family is considered as the most economically important dipteran family. The pests within this family are those that attack soft fruits.

Females of these species lay eggs under the fruit skin and the larvae develop in the fruit. Mature larvae leave the rotten fruit or fall with it to the ground where the larvae look for a hiding place to pupate.

Most control strategies are being applied against the adult phase of the flies. The most important tephritid species belong to the genera Anastrepha, Bactrocera, Ceratitis, Dacus and Rhagoletis. About 70 species are considered important agricultural pests and many others are minor or potential pests. The hosts of these flies belong to a wide variety of families of plants and include many major commercial crops.

Fruit flies cause enormous economic damage because they attack valuable commercial fruits and have the ability to disperse and exist in regions far from their original and natural habitat. For example, the Mediterranean fruit fly initiated in Africa and today is found in Australia, Europe, America (north and south) and Asia. Strict quarantine regulations are imposed on export countries in order to stop any further distribution. These quarantine regulations force the farmers that wish to export crops to apply intensive and expensive control systems to withstand these quarantine standards.

There are two important fruit fly pests in Israel: the Mediterranean fruit fly and the olive fruit fly. Recently two severe quarantine species have reached Israel: the lesser pumpkin fly and the peach fruit fly. Actions must be presently taken to stop further distribution of these species in Israel and toward Europe.

The most common and efficient system to control the fruit fly populations for more than 50 years is poison-bait sprays. The bait is a protein-based product fulfilling the need for protein of newly emerged females. The poison is mainly the organo-phosphorous Malathion.

Malathion is a cheap and efficient poison having relatively high LD₅₀ to warm blooded animals and it is thus safer to humans. Malathion has been used for more than 60 years and it is regarded as one of the most efficient poisons in the market.

The role of the bait is to reduce insecticides cost as well as the environmental contamination. However, due to the present strict regulations with respect to the content of residues of insecticides in food, crops contaminated with Malathion cannot be marketed.

Possible alternatives to using Malathion sprays are products such as “Success”, which is much more expensive (typically four times more expensive). “Success” is a ready-made marketed blend of Spinosad (biological insecticide safe to warm-blooded animals including humans) and a bait.

The use of traps can also keep fruits clean from insecticides. There are several options of baited traps in the market. Some known examples of traps are: Biofeed, Ronpal and Biolure. However, the common disadvantage of these devices is the high costs of the traps.

Another technique, which is still experimental, is the SIT (Sterile Insect Technique). This technique can work today only with the support of the other control systems.

Thus, in spite of the variety of control systems that are sold in the market, the fruit fly problem still exists and there is a need in the art for more efficient and not expensive methods to control fruit flies whilst keeping the fruits and the environment poisonous-free.

BRIEF DESCRIPTION OF THE SCHEMES AND FIGURES

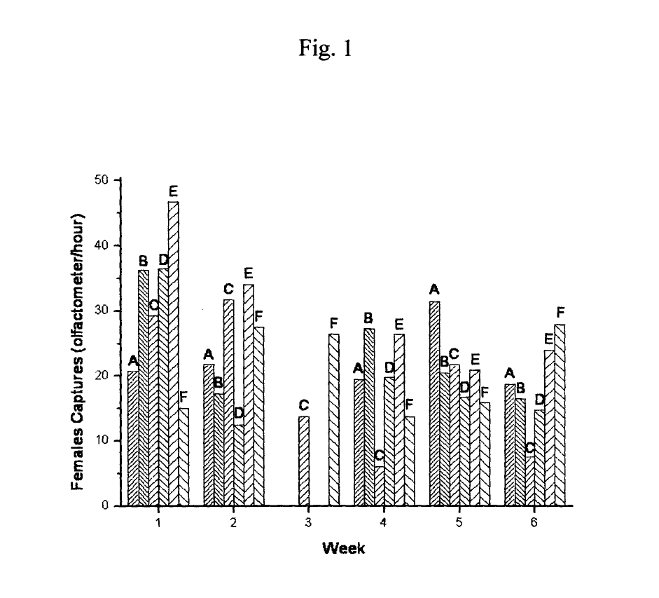

FIG. 1 depicts the female captures in olfactometer along time by 6 different compositions of solid bait (marked A-F) containing constant quantity of attractant.

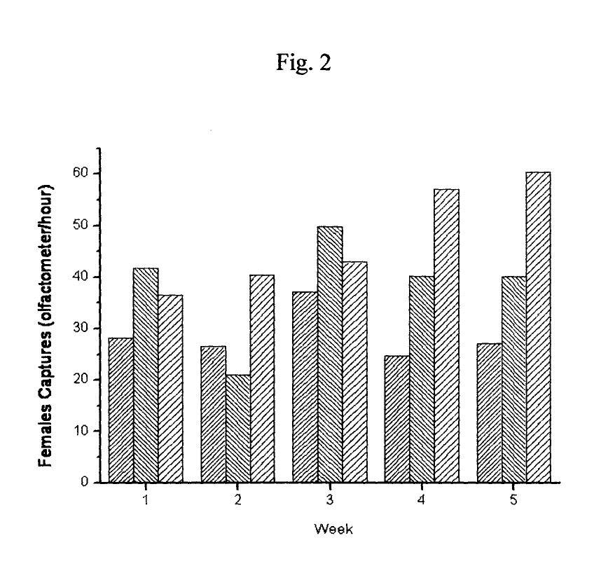

FIG. 2 depicts the female captures in olfactometer by solid bait containing increasing amounts of attractant I.

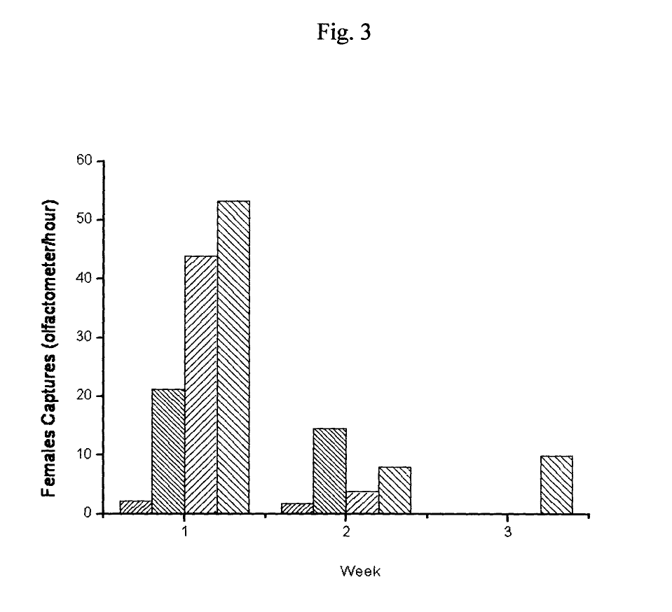

FIG. 3 depicts the female captures in olfactometer by solid bait containing increasing amounts of attractant II.

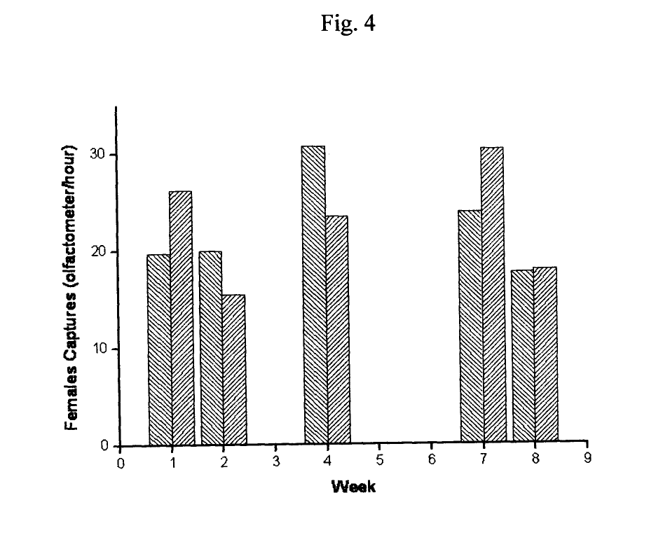

FIG. 4 depicts the female captures in olfactometer by solid bait containing 2 different amounts of attractant III.

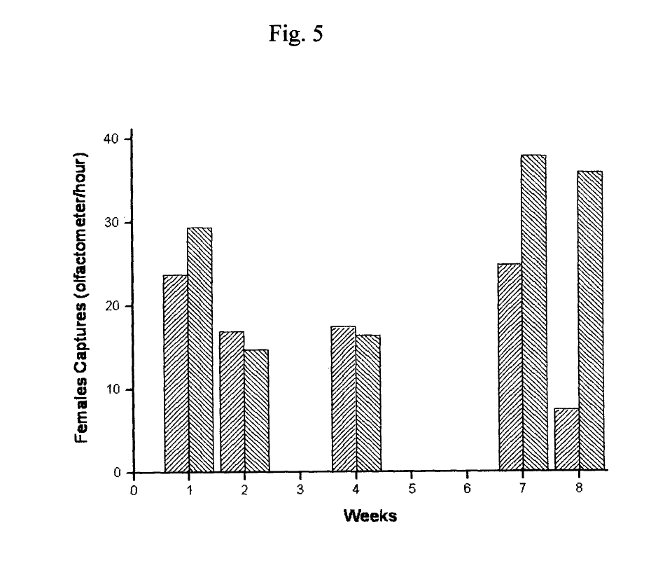

FIG. 5 depicts the female captures in olfactometer by solid bait containing 2 different amounts of attractant IV.

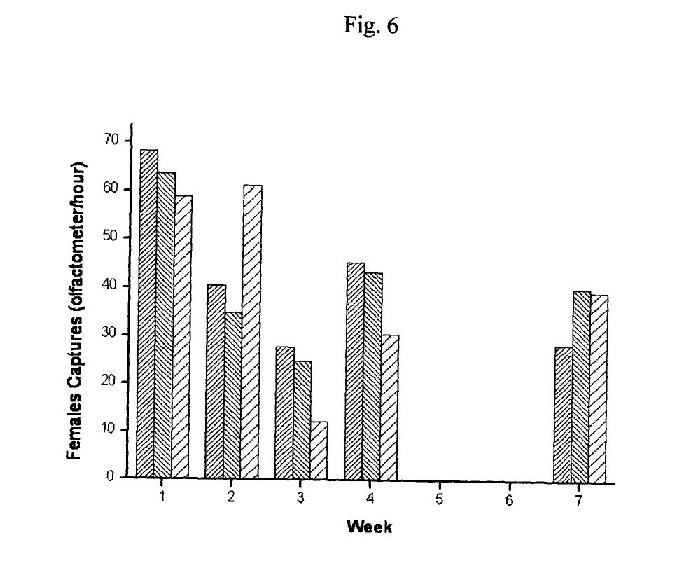

FIG. 6 depicts the female captures in olfactometer by solid bait containing water and aquatic solution of a commercial bait plus 3 different amounts of attractant I.

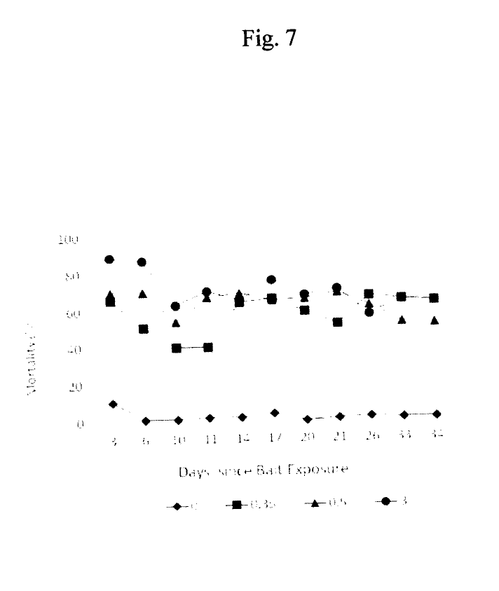

FIG. 7 depicts the percentage of mortality of protein-derived medfly females in the novel carrier having ammonia releasing substances as attractants, phagostimulants and different tracer concentrations.

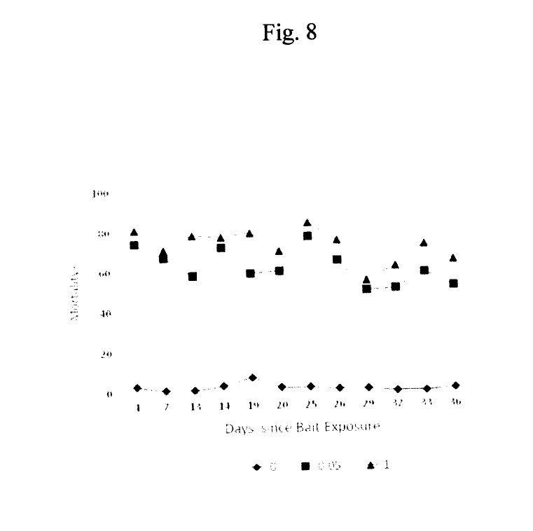

FIG. 8 depicts the percentage of mortality of protein-derived medfly females in the novel carrier having ammonia releasing substances as attractants, phagostimulants and different malathion concentrations.

### BRIEF SUMMARY OF THE INVENTION

The inventors of the present invention have developed a novel technology using fruit fly solid bait composition, which is applied as a paste smeared on brunches or on hanged plates, thus it has no contact with the fruit. The solid bait composition is characterized in that it is more attractive than other commercial baits, it is long lasting (at least 4 weeks) and it is destroyed at the end of the fly activity season.

Thus, the present invention provides a novel technology using low cost constituents, so the simple and cheap production contributes to the low price of the said bait

The present invention provides a technology, which is environmentally friendly, or “green” in addition to being cheaper technology than other technologies that are sold in the market.

According to an embodiment of the present invention, the said solid bait composition comprises an attractant or mixture of attractants, phagostimulants and an insecticide imprisoned in a core polymer or combination of polymers, a clay which can be a hydrated silicate, a salt, a humectants or combination of humectants and water.

According to another embodiment of the present invention, a preferred composition is created by combining a polymer such as alginate, pectin or chitosan with clays such as kaolinite and/or montmorilionite, including an insecticide such as Malathion or Spinosad, an attractant such as ammonium carbonate or ammonium citrate, a salt such as calcium chloride, humectants such as glycerol and/or ethylene glycol and water.

### DETAILED DESCRIPTION OF THE INVENTION

The inventors of the present invention have developed a novel technology using fruit fly solid bait composition, which is applied as a paste or hanged on a tree branch, thus it has no contact with the fruit. The said solid bait composition is characterized in that it is stronger than other commercial baits and it is long lasting (at least 3 weeks).

Thus, the present invention provides a novel technology using low cost constituents, so the simple and cheap production contributes to the low price of the said solid bait composition.

The present invention provides a technology, which is environmentally friendly, or “green” in addition to being a cheaper technology then other available technologies.

According to an embodiment of the present invention, the said solid bait composition comprises an attractant or mixture of attractants, phagostimulants and an insecticide imprisoned in a core polymer or combination of polymers, a clay which can be a hydrated silicate, a salt, a humectants or combination of humectants and water.

According to an embodiment of the present invention, the said solid bait composition comprises an attractant or mixture of attractants, phagostimulants and an insecticide imprisoned in a core polymer or combination of polymers, a clay which can be a hydrated silicate, a salt, a humectants or combination of humectants and water

According to an aspect of the present invention, the use of the solid bait without a trap reduces fruit flies control expenses.

According to another aspect of the present invention, the said solid bait may be used to control many species of fruit flies that are considered important agricultural pests. In Israel, the said bait can be used to control, e.g., two cardinal pests: the Mediterranean fruit fly (hereinafter or hereinbefore “medfly”) and the olive fruit fly and two quarantine pests: the lesser pumpkin fly and the peach fruit fly.

According to another aspect of the present invention, the said solid bait composition is characterized also in that in includes an ammonia releasing compound or mixture of compounds, which is the key attractant for the fruit flies

Thus, the attractant component is an ammonia releasing substance selected from ammonium acetate, ammonium bicarbonate, ammonium carbonate, ammonium citrate, ammonium sulfate, ammonium nitrate, ammonium hydroxide, ammonium carbamate, acetamide and combinations thereof.

According to another aspect of the present invention, the attractant component (ammonia) is being released from the solid bait surface by diffusion in a controlled rate along a period of time.

According to another aspect of the present invention, the said solid bait composition consists of water soluble components in an aquatic solution, wherein the characteristics of the said solution were examined by the inventors of the present invention and found superior in comparison to several comparable commercial baits.

According to another aspect of the present invention, the addition of phagostimulants such as carbohydrates, proteins, amino acids, nucleic acids and lipids contribute to the feeding stimulation of the said solid bait composition.

As used herein the term “Sterile Insect Technique (SIT)” is a method of biological control whereby a large number of sterile male insects are released and compete with the wild males for female insects. Since most of the males are sterile, when a female mates with the male then it will have no offspring, thus the next generation's population will be reduced. However, the sterile males are inferior to the wild males in getting mates, thus the SIT method is only partly efficient and cannot be used alone to replace the conventional methods.

As used herein, the term phagostimulant (based on the Greek word phagein meaning “to eat”) refers to compounds that stimulate feeding of, e.g., pests, such as carbohydrates, proteins, amino acids, nucleic acids and various lipids that are potential nutrients.

The term “humectant”, as used herein, refers to a hygroscopic substance having a molecule with several hydrophilic groups, most often hydroxyl groups, which has the affinity to form hydrogen bonds with molecules of water.

According to another aspect of the present invention, the insecticide, which ultimately turns the bait gel composition to be poisonous, is selected from biological pest control agents such as Spinosad, organophosphates such as Acephate, Azinphos-methyl, Bensulide, Chlorethoxyfos, Chlorpyrifos, Chlorpyriphos-methyl, Diazinon, Dichlorvos (DDVP), Dicrotophos, Dimethoate, Disulfoton, Ethoprop, Fenamiphos, Fenitrothion, Fenthion, Fosthiazate, Malathion, Methamidophos, Methidathion, Mevinphos, Monocrotophos, Naled, Omethoate, Oxydemeton-methyl, Parathion, Parathion-methyl, Phorate, Phosalone, Phosmet, Phostebupirim, Phoxim, Pirimiphos-methyl, Profenofos, Terbufos, Tetrachlorvinphos, Tribufos and Trichlorfon, carbamates such as Aldicarb, Bendiocarb, Carbofuran, Carbaryl, Fenoxycarb and Methomyl, pyrethroids such as Allethrin, Bifenthrin, Cyhalothrin, Cypermethrin, Cyfluthrin, Deltamethrin, Etofenprox, Fenvalerate, Permethrin, Phenothrin, Prallethrin, Resmethrin, Tetramethrin, Tralomethrin and Transfluthrin or IGRs (Insect Growth Regulators) selected from Nylar, Precor, Methoprene and Hydroprene and a combination thereof.

Preferably, the insecticide is a pest control agent such as Spinosad or an organophosphates such as, Malathion and a combination thereof.

According to another aspect of the present invention, the aquatic solid bait acquires its solidness by being imprisoned in a net composed of a clay and a polymer.

According to another aspect of the present invention, the clay is selected from hydrated silicates, silicoaluminates, dickite, bentonite, halloysite, kaolin or kaolinite, montmorilionite and combinations thereof

According to another aspect of the present invention, the polymer, which can be a polysaccharide, is selected from alginate, sodium alginate, hydroxypropyl methylcellulose, hydroxypropyl cellulose, cellulose hydrogel, methyl cellulose, ethyl cellulose, or cellulose esters such as cellulose acetate, pectin, chitosan and the like and combinations thereof.

According to another aspect of the present invention, the humectant can be selected from sorbitol, glycerine, ethylene glycol, propylene glycol, erythrithol and the like and combinations thereof.

According to another aspect of the present invention, the salt is typically an inorganic salt selected from sodium chloride, potassium chloride, calcium chloride, barium chloride, lithium chloride, sodium sulfate, and the like and combinations thereof.

According to another embodiment of the present invention, a preferred solid bait composition is created by combining a polymer such as alginate, pectin or chitosan with clays such as kaolinite and/or montmorilionite, including an insecticide such as Malathion or Spinosad and a combination thereof, an attractant or mixture of attractants such as ammonium carbonate or ammonium citrate, a salt such as calcium chloride, humectants such as glycerol and/or ethylene glycol and water.

According to another embodiment, the present invention provides a method of controlling fruit fly pests comprising exposing the said fruit fly pests to an effective amount of insecticide, which is contained in the solid bait composition described herein.

The present invention uses an olfactometer for the purpose of testing the solid bait compositions described herein, wherein the said olfactometer detects female captures by the response of the flies towards different odors that can be measured and be compared. The olfactometer was developed and described by Gothilf and Galun (1982), in “Olfactometer and trap for evaluating attractants for the Mediterranean fruit fly, Ceratitis Capitata. Phytoparasitica 10, 79-84”.

Thus, the present invention provides herein a novel solid bait composition, which can be efficiently used to control fruit flies, having an ammonia releasing attractant, wherein FIG. 1 depicts the female captures in olfactometer by 6 different solid bait compositions (marked A-F) containing constant quantity of attractant along time. It may be understood from the results that these compositions preserves their activity along time.

Experiments carried out with solid bait compositions containing different use levels of various attractants, marked as I-IV, are depicted in FIG. 2-5.

The example depicted in FIGS. 2-5 details two solid bait composition prototypes that include an ammonia releasing compound as the attractant, commercial bait as a phagostimulants source and an insecticide, Malation or tracer.

The amount of each component was determined after several series of tests for determining the optimal dosages. The laboratory control tests were carried out in round disposable 10 cm diameter plastic boxes. Each box contained 10 protein-deprived medfly females. Poisonous baits were smeared each on a transparency sheet cut to pieces of 1×2 cm. Sheet pieces with bait were left under field conditions between tests. A piece of sheet with the bait was hung under the interior surface of box cover. The flies were exposed to the bait for 3 hours and mortality was recorded every 10 minutes.

FIG. 6 depicts female captures observed in olfactometer by solid bail composition containing water and aquatic solution of a commercial bait plus 3 different amounts of attractant I.

FIG. 7 depicts the percentage of mortality of protein-derived medfly females in the novel carrier having ammonia releasing substance as attractant, phagostimulants and different tracer concentrations.

FIG. 8 depicts the percentage of mortality of protein-derived medfly females in the novel carrier having ammonia releasing substance as attractant, phagostimulants and different malathion concentrations.

### EXAMPLE

This example details two bait composition prototypes that include an ammonia releasing compound as the attractant, commercial bait as a phagostimulants source and an insecticide, Malation or tracer.

The amount of each component was determined after several series of tests for determining the optimal dosages. The laboratory control tests were carried out in round disposable 10 cm diameter plastic boxes. Each box contained 10 protein-deprived medfly females. Poisonous baits were smeared each on a transparency sheet cut to pieces of 1×2 cm. Sheet pieces with bait were left under field conditions between tests. A piece of sheet with the bait was hung under the interior surface of box cover. The flies were exposed to the bait for 3 hours and mortality was recorded every 10 minutes

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A solid bait composition comprising an attractant or mixture of attractants, phagostimulants and an insecticide imprisoned in a core polymer or combination of polymers, a clay, a salt, a humectants or combination of humectants and water.

2. The solid bait composition of claim 1, which is used to control fruit flies.

3. The solid bait composition of claim 1, which is characterized also in that it includes an ammonia releasing compound/s, which is the key attractant for the fruit flies.

4. The solid bait composition of claim 3, wherein the attractant component is an ammonia releasing substance selected from ammonium acetate, ammonium bicarbonate, ammonium carbonate, ammonium citrate, ammonium sulfate, ammonium nitrate, ammonium hydroxide, ammonium carbamate, acetamide and combinations thereof.

5. The solid bait composition of claim 4, wherein the attractant component (ammonia) is being released from the solid bait surface by diffusion in a controlled rate along a period of time.

6. The solid bait composition of claim 1, wherein the insecticide, which ultimately turns the bait gel composition to be poisonous, is selected from biological pest control agents such as Spinosad, organophosphates such as Acephate, Azinphos-methyl, Bensulide, Chlorethoxyfos, Chlorpyrifos, Chlorpyriphos-methyl, Diazinon, Dichlorvos (IMP), Dicrotophos, Dimethoate, Disulfoton, Ethoprop, Fenamiphos, Fenitrothion, Fehthion, Fosthiazate, Malathion, Methamidophos, Methidathion, Mevinphos, Monocrotophos, Naled, Omethoate, Oxydemeton-methyl, Parathion, Parathion-methyl, Phorate, Phosalone, Phosmet, Phostebupirim, Phoxim, Pirimiphos-methyl, Profenofos, Terbufos, Tetrachlorvinphos, Tribufos and Trichlorfon, carbamates such as Aldicarb, Bendiocarb, Carbofuran, Carbaryl, Fenoxycarb and Methomyl, pyrethroids such as Allethrin, Bifenthrin, Cyhalothrin, Cypermethrin, Cyfluthrin, Deltamethrin, Etofenprox, Fenvalerate, Permethrin, Phenothrin, Prallethrin, Resmethrin, Tetramethrin, Tralomethrin and Transfluthrin or IGRs (Insect Growth Regulators) selected from Nylar, Precor, Methoprene and Hydroprene and a combination thereof.

7. The solid bait composition of claim 6, wherein the insecticide, which ultimately turns the bait to be poisonous, is selected from Spinosad, Malathion and a combination thereof.

8. The solid bait composition of claim 1, which acquires its solidness by being imprisoned in a matrix composed of a clay and a polymer.

9. The solid bait composition of claim 8, wherein the clay is selected from hydrated silicates, silicoaluminates, dickite, bentonite, halloysite, kaolin or kaolinite, montmorilionite and a combination thereof.

10. The solid bait composition of claim 8, wherein the polymer is selected from alginate, sodium alginate, hydroxypropyl methylcellulose, hydroxypropyl cellulose, cellulose hydrogel, methyl cellulose, ethyl cellulose, cellulose acetate, pectin, chitosan and a combination thereof.

11. The solid bait composition of claim 1, wherein the humectant is selected from sorbitol, glycerine, ethylene glycol, propylene glycol, erythrithol and a combination thereof.

12. The solid bait composition of claim 1, wherein the salt is an inorganic salt selected from sodium chloride, potassium chloride, calcium chloride, barium chloride, lithium chloride, sodium sulphate and a combination thereof.

13. The solid bait composition of claim 1, which is created by combining a polymer selected from alginate, pectin, chitosan and a combination thereof with a clay selected from kaolinite, montmorilionite and a combination thereof, and includes an insecticide selected from Malathion, Spinosad and a combination thereof, an attractant selected from ammonium carbonate and ammonium citrate and a combination thereof, calcium chloride and a humectant selected from glycerol, ethylene glycol and a combination thereof and water.

14. The solid bait composition of claim 1, which is environmentally friendly, or “green”, having no contact with the fruits or the surrounding.

15. A method of controlling fruit fly pests comprising exposing the said fruit fly pests to an effective amount of insecticide, which is contained in the solid bait composition of claim 1.
